(19) United States
(12) Patent Application Publication
(10) Pub. No.: US 2009/0265952 A1
(43) Pub. Date: Oct. 29, 2009

(54) PORTABLE IN SITU CROP MATERIAL DRYER

(76) Inventors: Daniel J. Burke, Cordova, IL (US); Alan D. Sheidler, Moline, IL (US); Bill T. Hurley, Lawrenceville, GA (US)

Correspondence Address: Taylor & Aust, P.C/Deere & Company, P.O. Box 560, Avilla, IN, 46710, US

(21) Appl. No.: 12/108,666

(22) Filed: Apr. 24, 2008

(51) Int. Cl. F26B 3/04; F26B 9/00

(52) U.S. Cl. 34/218; 34/235

(57) ABSTRACT

A portable crop material dryer system for use with a flexible elongated bag in which harvested crop material is placed in situ. The dryer includes an internal combustion engine driving a blower for movement of air through the flexible container. The cooling system for the engine is connected to be in series flow relation to the air blower so as to heat the air and increase the drying capacity of the system. A burner may be connected to further increase the heating of the air and the power output of the engine may also be used to drive a generator for auxiliary purposes.

### FIELD OF THE INVENTION

The present invention relates to crop material dryers, and more specifically to crop material dryers deployable in the field.

### BACKGROUND OF THE INVENTION

In recent years, farmers around the globe have been collecting harvested crop material, such as grain, in large plastic silo bags or sacks directly in the field during the harvesting process. By collecting in this manner, the time consuming process of transporting the crop material to bin storage or elevators during the critical time of harvesting is minimized. This makes available man power to be focused solely on the process of harvesting the crop material in the field. Once in the bags the crop material may be collected later after the harvesting is complete, usually bringing a more favorable price.

One problem with this approach to collecting crop material is that there is limited ability to dry the crop material. The silo bags must be rugged enough and impervious to resist infiltration by rodents and other scavengers so that the bags do not have adequate natural porosity to enable air flow from the ambient air to dry. Furthermore, the crop material cannot be excessively high in moisture or it can spoil before retrieval. This makes the application of field bagging limited to more arid climates where rain damage is less likely or less frequent. The need for the crop material to be very dry for silo bags severely limits the time the farmer can wait until the crop material is dry enough before he can begin harvesting.

What is needed in the art therefore is an effective way to dry crop material in collection devices deployed in the field for harvested crop material.

### SUMMARY OF THE INVENTION

In one form, the invention is a portable in situ crop material dryer including a chamber deployable in a field for harvested crop material and an internal combustion engine providing a rotary output. An air movement device is coupled to and driven by the rotary output of the combustion engine. The heat exchange device receives a heat input from the combustion engine, the heat exchange device being in series flow connection with the air movement device. The air movement device is removeably fluidly coupled to the chamber for directing heated air through the chamber for drying harvested crop material.

In another form, the invention is a portable system for providing a flow of heated air in situ for drying harvested crop material. The system includes a frame and a combustion engine mounted on the frame and providing a rotary output to an air movement device coupled to and driven by the rotary output of the combustion engine. A heat exchange device mounted on the frame receives a heat input from the combustion engine, the heat exchange device being in series flow connection with the air movement device to increase the temperature of the air therethrough. Finally, an air outlet receives the air flow and the air outlet is removeably connectable to dry harvested crop material.

### BRIEF DESCRIPTION OF THE DRAWINGS

FIG. 1 is an elevational view of a dryer for crop material embodying the present invention along with a container of crop material for drying in situ; and

FIG. 2 is a schematic drawing of the crop material drying system described in FIG. 1.

### DETAILED DESCRIPTION OF THE INVENTION

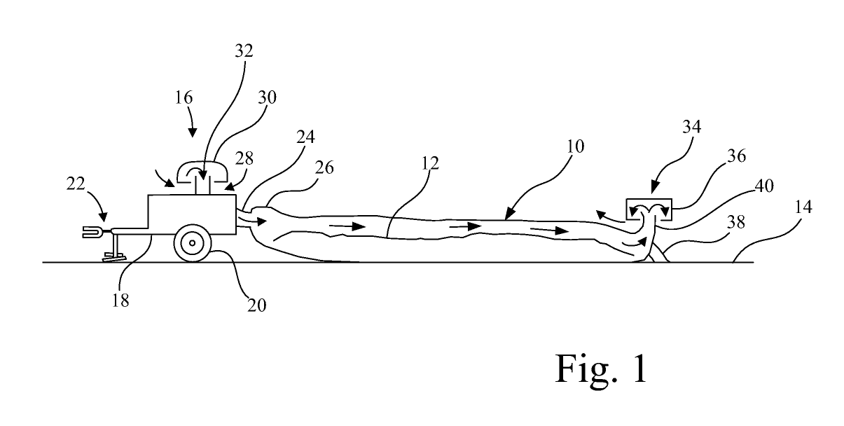

Referring to FIG. 1, there is shown a chamber 10 for storage of harvested crop material 12 in a field 14. The crop material may take the form of grain, corn stover and other The container 10 may take a number of forms but as shown herein it is an elongated flexible bag. The bag 10 is known as a harvest bag and usually consists of a specialized polymer bag that is elongated and can reach lengths up to 90 meters. The typical material for such bags is low density polyethylene and ethyl vinyl acetate. The manufactured film bag is soft, flexible and tough, even at low temperatures. The harvest bag 10 is used with crop material loading and extraction equipment (not shown). The loading and extraction equipment usually operates on the basis of an auger and when the bag is loaded with crop material the bag is deployed in an elongated fashion on the ground 14. Heretofore, the application of harvest bags has been limited to those areas of the world where ambient humidity is usually very low, such as in Australia and Argentina.

In accordance with the present invention a crop material drying unit, generally indicated by reference character 16, is incorporated with the harvest bag 10. The crop material drying unit 16 is shown as a portable unit for deployment in the field in situ and to that end has a trailer 18, ground wheels 20 and a hitch 22 for connecting to a truck or tractor. The crop material drying unit 16 has an outlet 24 removeably connected to one end 26 of the harvest bag 10. It should be apparent to those skilled in the art that an appropriate means for sealing the end 26 of bag 10 onto the outlet 24 would be employed. The crop material drying unit 16 has an ambient air inlet 28 where air passes under a rain cover 30 to dryer inlet 32. The air thus directed from inlet 28 to outlet 24 passes across the crop material 12 to a bag outlet 34, also having a rain cover 36 for discharge to the atmosphere. Appropriate support brackets 38 support a far end 40 of the harvest bag 10 in a vertical position so as to take advantage of the rain cover 36. It should be apparent to those skilled in the art, however, that the bag outlet 34 may be oriented other than strictly in a vertical position.

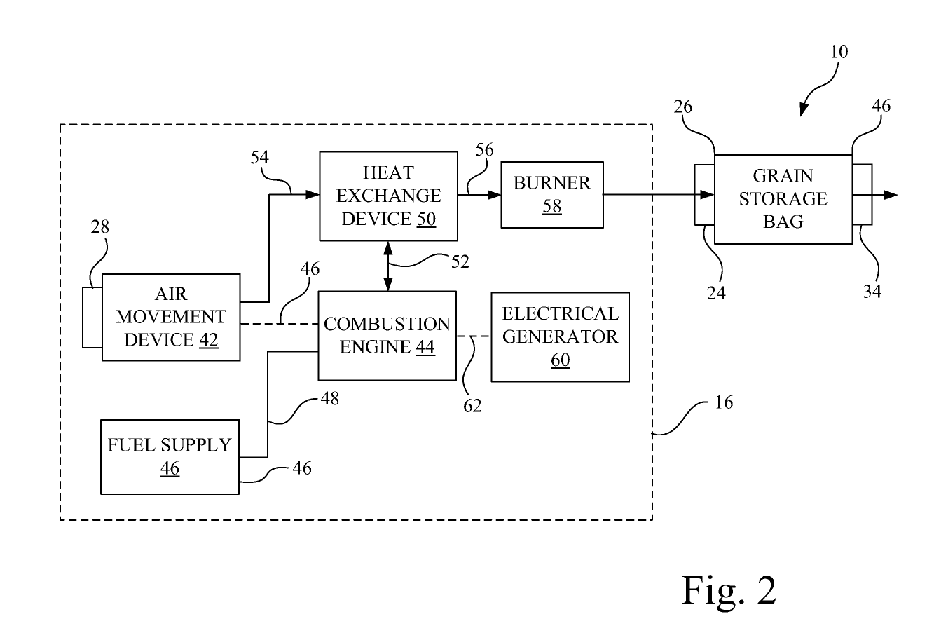

FIG. 2 shows a schematic arrangement of dryer unit 16, demarked by a dashed line. The air inlet 28 provides an air inlet to an air movement device 42 capable of moving sufficient volumes of air to properly ventilate harvest bag 10. The air movement device 42 may take many forms but it may be in the form of a squirrel cage blower, centrifugal blower or other blower appropriate for high air flow rates and sufficient pressure differential to promote air movement through the elongated harvest bag 10.

The air movement device 42 is driven by a combustion engine 44 providing a rotary mechanical output shown by dashed lines 46 to the air movement device 42. Combustion engine 44 may take a number of forms but they all involve an air breathing, fuel consuming, engine in which a fuel supply 46 is connected to combustion engine 44 by an appropriate fuel line 48. Major types of combustion engines are two cycle or four cycle reciprocating piston engines. Such engines may be spark ignited with a gasoline fuel supply or may be compression ignition ignited using the heat of compression to ignite a timed and metered diesel fuel charge in the engine combustion chambers (not shown). Although a compression ignition engine is suitable for use in the dryer 16, a spark ignition engine is preferable because it has a greater waste heat rejection to be utilized as discussed below.

A heat exchange device 50 is interconnected with the combustion engine 40 by a connection indicated by line 52. Heat exchange device 50 has a first path that is in heat exchange flow relationship to air discharged from the air movement device 42 through line 54 for heating the air to an elevated temperature and discharging it through line 56. In one form, the heat exchange device is a cooling system for the combustion engine 44. In the instance when combustion engine 44 is a liquid cooled engine, the heat exchange device 50 receives liquid coolant that is circulated from combustion engine 44 by an internal pump (not shown) and the heat exchange device 50 is a liquid to air heat exchanger. This means that the heat rejected by the combustion engine 44 is given up to the air passing through the heat exchange device 50 to provide a significant increase in temperature.

In the case where the combustion engine 44 is an air cooled engine, the heat exchange device 50 may take the form of an air to air heat exchanger in which air is directed across a finned outer housing for the engine combustion cylinder and the heat given up to the air passing through. In this case it would be appropriate to utilize the air movement device 42 to direct air over the fins in the heat exchange device 50 to also significantly increase the temperature of the air directed through the heat exchange device 50.

The engines described above are reciprocating internal combustion engines. It should also be noted that gas turbines may be utilized and in this case the heat exchange device would also be an air to air heat exchange device for increasing temperature of the air through line 56.

A burner 58 may optionally be employed in line 56 between heat exchange device 50 and outlet 24 to further increase temperature of the air thus discharged. Furthermore, an electrical generator 60 may be employed to be driven by combustion engine 44 through mechanical connection 62 to provide auxiliary electrical lighting and other power. It should be noted that with the additional load provided by the electrical generator, additional waste heat is generated in the heat exchange device 50 to further increase the temperature of the air flow from outlet 24.

The heated air is thus passed over the crop material 12 in harvest bag 10 and out the bag outlet 34. By heating the air passing across the crop material, the moisture of the crop material is decreased to the point where it becomes substantially more storeable for delivery to a bin, biomass facility or other processor.

In operation, the crop material dryer 16 is towed by an appropriate tractor or truck to a harvest bag 10 having crop material 12 already in it. The harvest bag 10 is purposely arranged so that some air space is available along the top of the harvest bag 10 so as to promote adequate air flow. The outlet of crop material dryer 16 is removeably connected to inlet end 26 of harvest bag 10 and the bag outlet 34 is deployed at the opposite end 40. The combustion engine 44 is operated and heated air flows through the harvest bag 10 and across the crop material 12. The increase in temperature lowers the humidity of the crop material. The crop material dryer 16 is self-contained and can be operated continuously and through the night until the moisture content of the crop material is at a sufficiently low level. The use of the electrical generator 60 allows operation at night. In addition the increased load imposed by the electrical generator 60 increases the waste heat of combustion engine which in turn increases the amount of heat delivered to the air through heat exchange device 50. When the crop material has reached a sufficiently low humidity level, the outlet 24 is removed from inlet 26 and bag outlet 34 is also removed. The harvest bag 10 may then be sealed for appropriate collection for delivery to a crop material silo or other collection means.

Having described the preferred embodiment, it will become apparent that various modifications can be made without departing from the scope of the invention as defined in the accompanying claims.

1. A portable in situ crop material dryer comprising:
a chamber deployable in a field for harvested crop material;
a combustion engine providing a rotary output;
an air movement device coupled to and driven by the rotary output of said combustion engine;
a heat exchange device receiving a heat input from said combustion engine, said heat exchange device being in series flow connection with said air movement device; and
said air movement device being removeably fluidly coupled to said chamber for directing heated air through said chamber for drying said harvested crop material.

2. A portable crop material dryer as claimed in claim 1, wherein said chamber is a flexible bag.

3. A portable crop material dryer as claimed in claim 2, wherein said flexible bag is elongated.

4. A portable crop material dryer as claimed in claim 3, wherein said elongated flexible bag has an air outlet remote from said air movement device.

5. A portable crop material dryer as claimed in claim 4, wherein said outlet has a rain cover.

6. A portable crop material dryer as claimed in claim 1, wherein said heat exchanger is a cooling system for said combustion engine.

7. A portable crop material dryer as claimed in claim 6, wherein said combustion engine has a liquid cooling system and said heat exchanger is a liquid to air heat exchanger for heating the air to said chamber.

8. A portable crop material dryer as claimed in claim 6, wherein said engine has an air cooled system and said heat exchanger is an air to air heat exchanger for heating said air.

9. A portable crop material dryer as claimed in claim 1, wherein said heat exchanger is downstream of said air handling device.

10. A portable crop material dryer as claimed in claim 1, further including a burner in said air flow stream and down stream of said heat exchange device for further increasing the temperature of air through said chamber.

11. A portable crop material dryer as claimed in claim 1, further including an electrical generator driven by the rotary output of said combustion engine for providing auxiliary electric power.

12. A portable crop material dryer as claimed in claim 1, wherein said air movement device is a blower driven by said combustion engine.

13. A portable system for providing a flow of heated air in situ for drying harvested crop material, said system comprising:
a frame;
a combustion engine mounted on said frame and providing a rotary output;
an air movement device coupled to and driven by the rotary output of said combustion engine;
a heat exchange device receiving a heat input from said combustion engine, said heat exchange device being in series flow connection with said air movement device to increase the temperature of the air therethrough;
an outlet on said frame receiving the air flow output from said heat exchange device, said outlet being connectable to dry harvested crop material.

14. A portable system as claimed in claim 13, further including wheels on said frame and a hitch for connection to a transport vehicle.

15. A portable system as claimed in claim 13, further including an air intake on said frame for air to be heated and circulated to said crop material, said air intake having a rain cover.

16. A portable system as claimed in claim 13, further including a generator driven by the rotary output of said combustion engine for providing auxiliary electric power.

17. A portable system as claimed in claim 13, further including a burner downstream of said heat exchange device for further increasing the temperature of said air to dry said crop material.

18. A portable system as claimed in claim 13, further including a fuel supply on said frame for supplying the fuel combustion engine.

19. A system as claimed in claim 13, wherein said heat exchanger is a cooling system for said combustion engine.

20. A portable system as claimed in claim 19, wherein said engine is liquid cooled and said heat exchanger is a liquid to air cooling system for said engine for receiving liquid at an elevated temperature and heating the air flowing to said crop material.

21. A portable system as claimed in claim 19, wherein said engine is air cooled and said heat exchanger is an air to air heat exchanger receiving heated air from cooling said engine and heating the air flowing to heat said crop material.

22. A portable system as claimed in claim 13, wherein said heat exchanger is down stream of said air handling device.

23. A portable system as claimed in claim 23, wherein said air movement device is a blower.
